(19) United States
(12) Patent Application Publication
(10) Pub. No.: US 2005/0071333 A1
(43) Pub. Date: Mar. 31, 2005

(54) Method for determining synthetic term senses using reference text

(76) Inventors: James C Mayfield, Silver Spring, MD (US); Christine D Piatko, Columbia, MD (US); J Paul McNamee, Ellicott City, MD (US)

Correspondence Address: Benjamin Y Roca Office of Patent Counsel;The Johns Hopkins University, Applied Physics Laboratory, 11100 Johns Hopkins Road, Laurel, MD, 20723-6099, US

(21) Appl. No.: 10/471,483

(22) PCT Filed: Feb. 27, 2002
(86) PCT No.: PCT/US02/06027

Related U.S. Application Data
(62) Division of application No. 60/271,960, filed on Feb. 28, 2001.

(51) Int. Cl. G06F 7/00

(52) U.S. Cl. 707/5

(57) ABSTRACT

A method for determining term senses by identifying terms having multiple “senses” or meanings. For a given source term and trigger term, a list of important terms having high relevance to a combination of the source term and trigger term is created. The list of important terms is determined to be a “sense” for the source term in accordance with the present invention. A sense is assigned to a given term of a given document by determining similarity of the document to one or more senses and assigning a sense as a function of the degree of similarity. A sense-indicative index is created to treat multiple occurrences of a term distinctly, as a function of each respective assigned sense. Accordingly, the index may be used for sense-relevant information retrieval when a sense of a query term is discernible or specified.

### CROSS-REFERENCE TO RELATED APPLICATIONS

This application claims the benefit of prior filed co-pending U.S. Application Nos. 60/271,962 and 60/271,960, both filed Feb. 28, 2001, the disclosures of which are hereby incorporated herein by reference.

### BACKGROUND OF THE INVENTION

1. Field of the Invention

The present invention relates generally to computerized systems for processing, searching and retrieving information. In particular, the present invention relates to techniques for determining a “sense” for a term that may be used, for example, to provide more accurate search results by seeking to match not only search terms but also the search term's sense.

2. Description of the Related Art

Computerized text-based information retrieval systems are now in widespread use in database, intranet and internet (e.g., World Wide Web) applications. Such systems typically search a large group of documents according to search query terms provided by a user to identify a subset of documents of the group of documents that are likely of interest to the user based on the search query terms. Since a very large number of search results is typically obtained, it is burdensome to the user to identify the relatively few documents that are actually of interest to the user.

This problem is exacerbated by the fact that many document terms and search terms have multiple contextual meanings. As used herein, “term” is used broadly and may include, for example, a word, a stemmed word, a character n-gram, phrase, or any other grouping that may be used to characterize text. Term meanings are typically not accounted for as part of the automated search process. For example, when a term has more than one “sense”, documents are often returned as search results when there is a term match, but not necessarily a sense match. For illustrative purposes, consider a Web-based search engine operated by a user to search the Web for documents relating to the search term “jaguar”. The term “jaguar” has multiple senses, including an automotive sense, an animal sense, and a sports sense. As a result, when the search engine retrieves documents that contain the word “jaguar”, some will likely relate to Jaguar cars, others will likely relate to jaguar animals, and yet others will likely relate to a Jaguars football team. This is undesirable because a user must review an unnecessarily large set of search results including all such senses of the search term, although the user may be interested only in documents in which the term is used in one of the term's senses.

What is needed is a method for determining a term's sense for facilitating automated sense-relevant information retrieval.

### SUMMARY OF THE INVENTION

The present invention is directed toward a method and apparatus for determining synthetic term senses for facilitating automated sense-relevant information processing, such as automated sense-relevant information retrieval. Conceptually, the present invention can be embodied in two principal aspects, which may be combined. The first aspect may involve using reference text, e.g. a group of documents, to determine senses of terms. In effect, this establishes a “library” of senses for terms in the large body of documents. This may be performed before any search queries are processed, and/or may be ongoing as new documents are added to the collection. In contrast to using a dictionary to identify a “sense”, this method is advantageous because it provides “synthetic senses”—some of which likely cannot be found in a dictionary. Additionally, this method excludes dictionary senses that do not appear in the reference text, and therefore are of little relevance when searching reference text. The senses are “synthetic” in that they are based on document collection statistics, e.g. term frequencies, rather than dictionary definitions.

The second aspect involves assigning an appropriate sense to a term in a given document or query. In effect, this provides an indication of the terms' senses for each document in the large body of documents. For example, the term's sense for a given document may be used for sense-relevant information retrieval, cross-language translations, etc.

Once term senses have been determined and/or assigned in accordance with the present invention, sense-relevant automated information retrieval may be performed using known information retrieval and indexing techniques by using appropriate term senses in the index and in the query instead of unsensed terms, i.e. terms to which senses have not been assigned.

In addition to sense-relevant automated information retrieval, the present invention may be used to provide senses for use in the context of a thesaurus, a cross-language dictionary, or a document index.

### BRIEF DESCRIPTION OF THE DRAWINGS

FIG. 1 is a flow diagram illustrating an exemplary method for determining senses for a source term according to the present invention;

FIG. 2 is a flow diagram illustrating an exemplary method for assigning a sense to a term of a document according to the present;

FIG. 3 is a flow diagram illustrating an exemplary method for creating a sense-indicative index according to the present invention;

FIG. 4 is a flow diagram illustrating an exemplary method for invention refining senses for a source term according to the present invention; and

FIG. 5 is a block diagram of an information retrieval system in accordance with the present invention.

### DETAILED DESCRIPTION

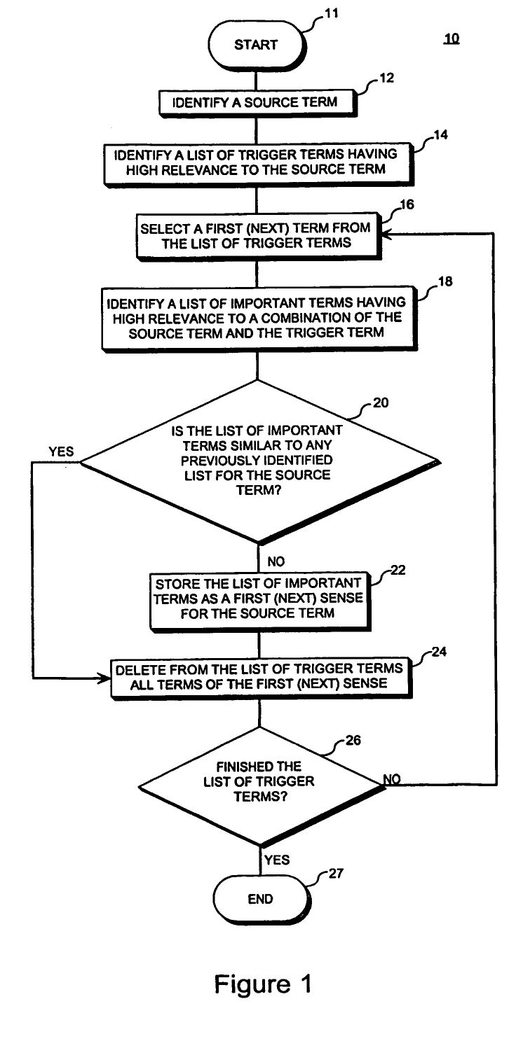

FIG. 1 is a flow diagram 10 illustrating an exemplary method for determining senses for a source term according a first aspect of the present invention. As used herein, a “source term” is a term for which it is desired to determine senses. As shown in FIG. 1, the method starts with identification of a source term, as shown at steps 11 and 12. The source term may be identified in any suitable manner. For example, a source term may be arbitrarily or randomly selected, specified by a user, etc. Alternatively, for a given group of documents that are desired to be classified and/or searched by sense, the documents may be indexed to identify the most frequently occurring terms and terms having a frequency above a desired threshold may be treated as source terms in order of decreasing frequencies. Various indexing techniques are well known in the art. Any suitable alternative may be used to identify a source term, as will be understood by those skilled in the art. Preferably, a method for selecting source terms is used so that all or nearly all document terms (e.g. excluding stop terms) are eventually selected as source terms.

A list of trigger terms is then identified, as shown at step 14. As used herein, a “trigger term” is a term that is selected for use to identify senses for a source term. Accordingly, it is often advantageous that each of the trigger terms has a relatively high relevance to the source term, i.e. it is related to the source term. Any suitable method may be used for identification of trigger terms. Various techniques are known in the art for finding terms relating to a given term, such as those that involve use of the Jaccard coefficient, the cosine coefficient, and Yule's coefficient, as are well known in the art.

For example, trigger terms may be identified as terms of an affinity set as described in U.S. Provisional Application No. 60/271,962. Generally, the affinity set technique identifies as terms important to a subset of documents, those terms that appear more frequently in the subset than in the entire set of documents. For example, that technique involves determining a frequency of occurrence within sample text of terms of the sample text. Each term's frequency for the sample text is then compared with a reference frequency, such as the term's frequency of occurrence within a reference text, e.g. a large text sample. Importance to the sample text is determined as a function of a difference between the frequencies. An importance score is assigned to each of the plurality of terms of the target text and an affinity set is defined to include terms of sufficient importance, e.g. as reflected by an importance score exceeding a desired threshold. By using the source term as a search query to identify the sample text, the important terms of the sample text are terms related to the source term, and these important terms may be used to help define different senses of the source term, and so are useful as trigger terms for the present invention.

As an illustration of steps 12 and 14, consider that “red” is selected as a source term, and that “wine, cabernet, cross, merlot, fiscal” are identified as trigger terms that are related to red and that are likely usable to determine senses of “red.” For this example, it is assumed that each trigger term has been assigned an importance score and that the list has been sorted in order of decreasing importance score. It must then be determined what are the senses of “red”, or more specifically, what words should be grouped with “red” to define a first sense, a second sense, etc. This is achieved in steps 16-24, as discussed below.

A first term from the list of trigger terms is then selected, as shown at step 16 of FIG. 1. For example, the trigger term having the highest importance score may be selected first, if the trigger terms have been assigned importance scores. Subsequent trigger terms may then be selected in order of decreasing importance score. Accordingly, consider that “wine” is selected as the first trigger.

A list of important terms having high relevance to a combination of the source term and the trigger term is then identified, as shown at step 18 of FIG. 1. This may be carried out using any suitable method. For example, the source term and trigger term may be combined in a search query with a Boolean AND operator, and the search query may be executed to search reference text, the search results being used as the sample text, and the affinity set technique described above may be used to identify an affinity set including important terms of the sample text. Alternatively, the important terms may be the terms that appear most frequently, the terms appearing with a frequency above a threshold, the top X most frequently appearing terms, etc. Other suitable methods for determining important terms will be apparent to those skilled in the art and any suitable method may be used. This list of important terms is referred to herein as a “sense” of the source term. More specifically, the sense is a list of terms that often co-occur with the source term when the source term is used in an associated sense, with a certain meaning, in a certain context, etc.

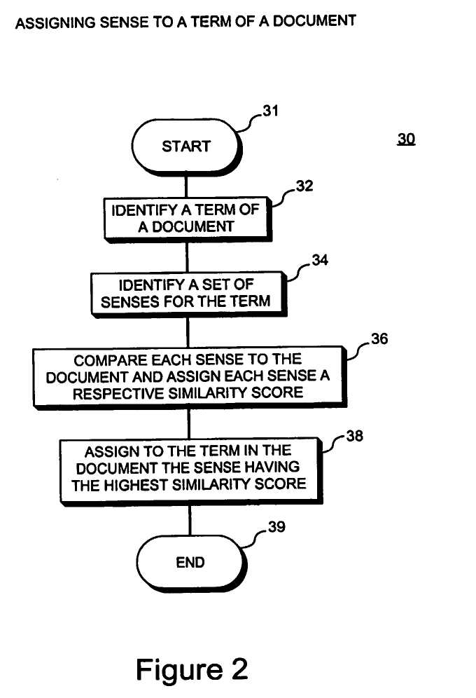

To illustrate step 18 of FIG. 1, consider that a query including “red” and “wine” is executed to identify relevant documents. The relevant documents are then analyzed, e.g., using the affinity set technique described in U.S. Provisional Application No. 60/271,962, to identify important terms including “cabernet, merlot, blush, grape, vineyard, tasting”. These important terms define a first sense for the term “red”, namely, a sense associated with wine. Accordingly, any documents containing these terms, and the term “red”, is probably using “red” in the context of wine. Additionally, any document containing the term “red”, and being significantly similar to this sense, i.e. list of important terms, is probably using “red” in the context of wine. Various methods are known for determining similarity of documents, and any suitable method may be used, such as a cosine measure, a probabilistic measure, etc. According to the present invention, the list of terms of the sense is treated as a document and a known similarity technique is used to determine similarity to assign a sense, as discussed in greater detail below with reference to FIG. 2.

Optionally, as shown in FIG. 1, each new sense determined in step 18 is compared to each previously determined sense for a given source term to determine similarity, as shown at step 20. Various techniques are known for determining such similarity and any suitable technique may be used. For example, such techniques include cosine measures, probabilistic measures, and other techniques well known in the art. If a high degree of similarity exists (according to user or system preferences), it may be advantageous to skip to the next trigger term (e.g. by skipping to step 24, as shown), or to stop the process of FIG. 1 (i.e. to end by skipping to step 27) and/or to repeat the process of FIG. 1 for a next source term. Such similarity indicates that the same or very similar senses are being repeatedly identified. It has been determined that once this begins to happen, it happens very frequently, and relatively few new senses will likely be found, at least during the present iteration of FIG. 1.

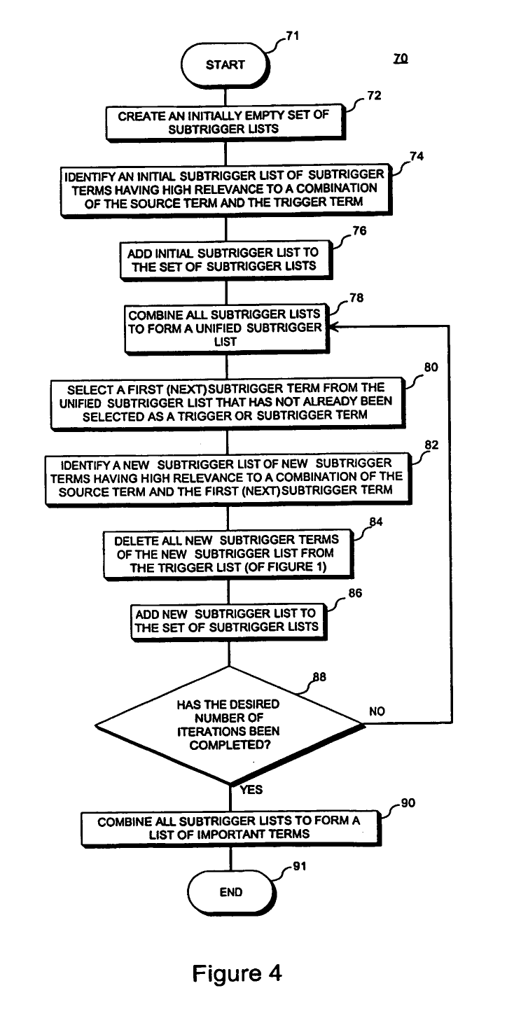

Optionally, the sense for the source term determined in step 18 is stored as a first sense, e.g. in a memory of an information processing system, as shown at step 22 of FIG. 1. This sense may be referenced later as necessary, e.g. when assigning a sense to a term of a document, as discussed below with reference to FIG. 4.

Although a first sense of the source term has been identified, it is likely that additional senses exist. Accordingly, it is useful to repeat the process to identify additional senses for the source term. To enhance efficiency of the process, and to prevent identification of highly similar senses, the terms from the first sense are first deleted, removed, or otherwise flagged as used or unusable, etc., from the list of trigger terms identified in step 14, as shown at step 24. In this manner, terms associated with the first sense will not be used as trigger terms when trying to find a next (different) sense. Then, if the end of the list of trigger terms has not yet been reached, a next term is selected from the list of trigger terms and steps 16-26 are repeated, as shown. The process of FIG. 1 ends when the end of the list of trigger terms is reached, as shown at steps 26 and 27. At this point, multiple senses have likely been determined for the source term.

To illustrate, consider that the terms “cabernet” and “merlot” (the only terms appearing in the sense list of important terms and the trigger term list) are deleted from the trigger term list in step 24. The next trigger term, “cross” is then selected in step 16 and is combined with “red” to form a query used to identify another set of search-relevant documents. Important terms of these documents are identified as “blood, donations, international” in step 18 and define a second sense for the term red, namely a sense associated with the Red Cross organization. Accordingly, any documents containing these terms, and the term red, is probably using “red” in the context of the Red Cross.

Preferably, the method of FIG. 1 is repeated for subsequent source terms until multiple senses have been identified for all source terms. This creates a “library” of senses for use in assigning senses to document terms as discussed below with reference to FIG. 2.

FIG. 2 is a flow diagram 30 illustrating an exemplary method for assigning a sense to a term of a document according to a second aspect of the present invention. This method considers that a “library” of senses has already been established. As shown in FIG. 2, the method starts with the identifying of a term of a document, as shown at steps 31 and 32. The term may be identified in any suitable manner. For example, the document may be indexed to find a frequency of occurrence of each term within the document and the terms may be identified in order of decreasing frequency. Alternatively, the terms may be identified in order of their first appearance in a document.

A set of senses for the term is next identified, as shown at step 34. For example, this step may include referencing a database of senses stored in a memory of an information processing system, e.g. those stored in step 20 of FIG. 1.

In the example of FIG. 2, each sense is compared to the document and assigned a respective similarity score according to its degree of similarity to the document, as shown at step 36. Many suitable techniques are known in the art for determining document similarity and assigning a similarity score. Any suitable method for determining similarity may be used. In accordance with the present invention, the sense, i.e. the list of terms, is treated as a document for the purpose of determining similarity to another document.

In the example of FIG. 2, the term is assigned the sense having the highest respective similarity score, as shown at step 38, and the method ends, as shown at step 39. Suitable alternatives for assigning a sense having sufficient similarity will be apparent to those skilled in the art. For example, senses may be identified and compared sequentially until a similarity score above a desired threshold is obtained, at which point the corresponding sense may be assigned to the term. It should be noted that the method of FIG. 2 may be used to assign a single sense to all occurrences of the term in the document, which is generally acceptable. Alternatively, the document may be divided into smaller units (e.g. sentences, or the n terms preceding and the n terms following an occurrence of a source term), and senses may be assigned to each such unit separately.

In some embodiments, if a term is not sufficiently similar to any known (previously identified) sense, the term is assigned a generic sense indicating that the sense is presently unknown or cannot yet be classified. Terms assigned to such a class may be later assigned a sense as additional senses are identified (e.g. as the steps of FIGS. 1 and 2 are repeated) and/or through sense-refinement, as discussed below with respect to FIG. 4.

Preferably, but not exclusively, the method of FIG. 2 is repeated for each term (or selected term) of the document, and for each document of the group of documents. Accordingly, each document is provided with sense-relevant information that may be used for sense-relevant information retrieval purposes, cross-language translations, etc.

Accordingly, after step 2, terms that have been assigned a sense according to FIG. 2 are distinguishable from one another. In particular, the terms may be distinguishable by indexing software. Various indexing software and techniques are well known in the art.

Various approaches can be used to cause standard/known indexing software to distinguish between terms to which senses have been assigned. In one embodiment, sense-distinctive string equivalents may be inserted into the text. For example, consider that the term “bank” is determined to have ten different senses, and that “bank” in a certain document has the fourth sense. Accordingly, the sense-distinctive string “bank#4” may be substituted into the document for each occurrence of “bank” so that when a usual indexing method is performed on the document “bank#4” appears distinct from “bank#3”, “bank#2”, etc. appearing in other documents. When a search query is performed for “bank#4”, or a user provides a search term of “bank” and it is specified by the user or determined by a system that the fourth sense is sought, appropriate documents may be identified in a straightforward manner using known information retrieval techniques, as will be apparent to those skilled in the art. Exemplary, but not limiting, methods for identifying a sense for a search query are provided below.

In an alternate embodiment, sense determinations are made dynamically as a document is indexed. More specifically, as each term of the document is identified for indexing purposes as known in the art, the term's sense is determined according to the method of FIG. 2. Then, a reference representing that sense of the word may be created or specified for further processing in the same way that the system represents a new, distinct term, e.g. the string “bank#1” or an integer not already used to represent any other term or sense. This requires straightforward modification of known indexing techniques to incorporate the method of FIG. 2 where appropriate, as will be apparent to those skilled in the art.

In yet another alternative embodiment, senses are assigned to an internal representation of each document, not to the document itself. For example, an information retrieval system may internally represent a document as a document identifier, followed by a list of terms or term identifiers (collectively “term identifiers”) contained in the document, and an occurrence count for each of those term identifiers. A sensed version, i.e. a version in which senses have been assigned to term identifiers, of such an internal representation may be created by performing the process of FIG. 2 for each term identifier to determine which sense of the term identifier is most similar to the document, and replacing the original term identifier with a new term identifier representing the desired sense, e.g. to replace “bank” with “bank#3”. This process may be applied to each document representation. Other data structures (e.g., an ‘inverted index’) that are part of the index can then be rebuilt by referring to the new document representations including the new term identifiers. Alternatively, other data structures may be modified to reflect the identified senses. For example, an inverted index typically includes a pairing of each term identifier with a list of document identifiers indicating the documents that contain that term. To create a sense-indicative index, each such pairing is replaced by a set of pairings, one for each term sense, each of which associates the term identifier for a certain sense with a list of document identifiers indicating the documents associated with that sense. The sense-indicative index may then be used for information retrieval purposes in a straightforward manner, provided that a sense of a search term and/or query may be discerned or is provided.

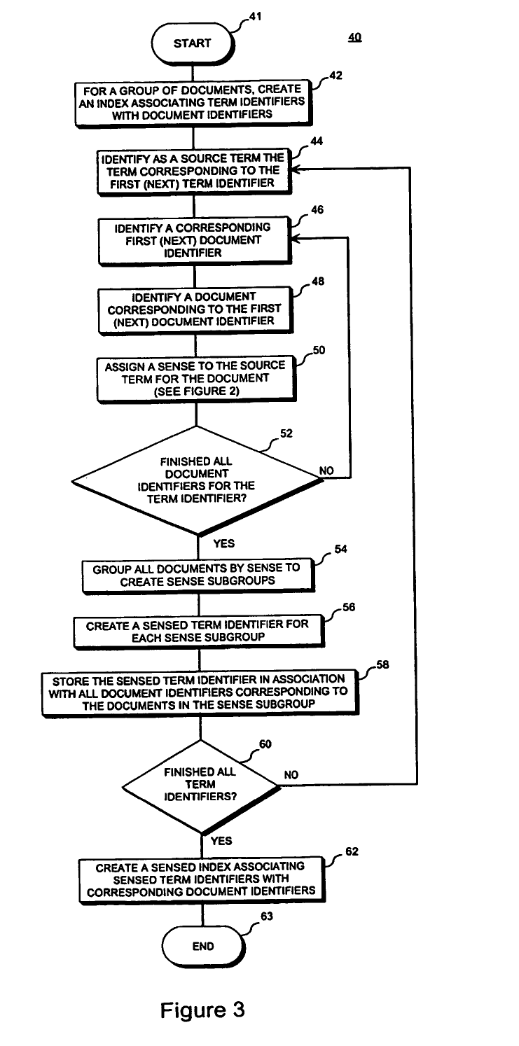

By way of further example, FIG. 3 is a flow diagram 40 illustrating an exemplary method for creating a sense-indicative index according to the present invention that may be used, for example, for sense relevant information retrieval. As shown in FIG. 3, the method starts with creating an index for a group of documents using any well-known indexing method, as shown at steps 41 and 42. In this example, the index associates term identifiers with document identifiers to indicate that a term corresponding to a given term identifier may be found in documents corresponding to the associated document identifiers. For each term identifier, a corresponding term is identified, and the term is assigned a sense for each document in which it appears, using the method of FIG. 2 as described above. This is repeated for all document identifiers (and corresponding documents) for a given term identifier (and corresponding term), as shown at steps 44-52. When all document identifiers have been considered, and sense assigned, all documents corresponding to the document identifiers associated with the given term identifier are grouped by sense to create sense subgroups, as shown at step 54. For example, if term identifier A is associated with document identifiers 1,2 and 3, and the term is assigned sense Y for documents 1 and 3 and sense Z for document 2, documents 1 and 3 are grouped for sense Y and document 2 is grouped for sense Z. A sensed term identifier is then created for each sense subgroup, e.g. TermIdentifierY, TermIdentifierZ, as shown at step 56. The sensed term identifier is then stored in association with all document identifiers corresponding to the documents in the sense subgroup, as shown at step 58. For example, TermIdentifierY would be stored in correspondence with the document identifiers for documents 1 and 3. This is repeated for all term identifiers as shown at step 60. From this information, a sensed index is created as shown at step 62 to associate the sensed term identifiers with corresponding document identifiers. In this manner, a new index has been created that is sense-indicative, and each term identifier from the index is replaced with one or more sense-indicative term identifiers, each of which is associated with a different sense of the associated term. Each of the sense-indicative identifiers can then be treated as a unique term by an information retrieval system referencing the sense-indicative index to allow for sense relevant information retrieval when a sense for a search term and/or query is known. Because the sense differentiation is performed at the document and/or index level, known information retrieval techniques may be used with little or no modification, as will be apparent to those skilled in the art.

A sense for a search term and/or query may be determined in various ways. For example, a search query provided by a user is treated as a document and the method of FIG. 2 is used to identify a sense for each term of the search query.

Alternatively, a user entering a term into a search engine is asked to specify a sense, e.g. by picking from a pick list displayed to the user and showing terms for each sense, using prior knowledge of the user or a user-profile to determine a likely sense, etc. Alternatively, the search query may be executed on an unsensed group of documents, i.e. a group to which senses have not been assigned, to retrieve documents, the senses of terms in those documents may be identified “on the fly”, e.g. as part of the document retrieval process, or in a pre-search processing step, and a most common sense for each of the search term(s) may be used as the query that is executed against the sensed collection of documents. Various other techniques will be apparent to those skilled in the art and any suitable technique may be used.

It should be noted that sensing of the documents and/or an index of the documents may be refined by repeating the steps of FIGS. 1 and 2 for a given body of documents. In effect, the first iteration applies sense to an unsensed collection of documents, while the second iteration applies senses to a sensed collection of documents. By identifying senses in a collection of documents to which senses have already been assigned, cross-pollution of senses is reduced, and more subtle senses may be detected. The resulting sense may be applied either to the sensed document collection, or to the original unsensed collection.

FIG. 4 is a flow diagram 70 illustrating an exemplary method for iteratively refining a sense for a source term according to the present invention. Optionally, this method for refining senses for a source term may be used to implement step 18 of FIG. 1. It may be desirable to use this method because a sense initially identified may include terms that actually represent more than one sense. This method helps to refine the senses so that multiple “senses” of a term are not conflated in a single sense. As shown in FIG. 4, the method starts with creation of an initially empty set of subtrigger lists, as shown at steps 71 and 72.

An initial subtrigger list is identified that includes subtrigger terms having high relevance to a combination of the source term and the trigger term, as shown at step 74. As used herein, a “subtrigger term” is a term that is selected for use to identify senses for a source term, and preferably is a term related to the source term. Such terms may be identified using the affinity set technique described in U.S. Provisional Application No. 60/271,962 and as discussed above. More specifically, the source term and trigger term are used to identify documents used as the sample text, and important terms of such documents (e.g. as determined using the affinity set technique) are used as the subtrigger terms.

The initial subtrigger list is then added to the set of subtrigger lists and all subtrigger lists are combined to form a unified subtrigger list including all subtrigger terms from all subtrigger lists, as shown at steps 76 and 78. The terms of the unified subtrigger list are preferably ranked in order of importance, e.g. in order of decreasing importance score. For example, the importance score for a term in the unified subtrigger list that appears on one or more subtrigger lists may be determined to be equal to its worst rank on any individual substrigger list, or equal to its worst score on any individual subtrigger list.

A first subtrigger term is then selected from the unified subtrigger list, as shown at step 80. This subtrigger term is a term that has not already been selected as a trigger term (e.g. in FIG. 1) or as a subtrigger term (e.g. in FIG. 4, as discussed further below).

A new subtrigger list is then identified that includes terms having high relevance to a combination of the source term and the first subtrigger term, as shown at step 82. For example, such terms can be identified using the affinity set technique, wherein the source term and first subtrigger term are used to identify documents used as the sample text, and wherein the important terms of such documents are used as the new subtrigger terms.

All terms from the new subtrigger list are then deleted from the list of trigger terms identified in step 14 of FIG. 1, as shown at step 84. The new subtrigger list is then added to the set of subtrigger lists as shown at step 86. These steps (78 to 86) may be repeated for as many iterations as desired, as shown at step 88. More iterations generally providing a higher degree of sense refinement but an increased processing costs. It has been found that between 1 and 3 iterations provide adequate results. If the desired number of iterations has been completed, the sense refinement process ends with combination of all subtrigger lists to form a list of important terms, as shown at steps 88, 90 and 91. The list of important terms is then stored as a sense for the source term, as shown at step 22 of FIG. 1. By way of example, each important term appearing on multiple term lists may be assigned a respective importance score equal to its worst rank or its worst score on any individual subtrigger list before those lists are combined and ordered according to importance score.

It should be noted that the present invention is useful for various purposes beyond automated information retrieval discussed above for illustrative purposes. For example, the present invention may be used in the context of a thesaurus, a dictionary for cross-language translation, for document translation, or to compose a search query in a foreign language to search foreign documents as a function of a search query in a primary (native) language. For example, consider that English is the primary language and translations in French are desired to be searched. Further consider that an English language large text sample and a French language large text sample that is an aligned, parallel collection of the English language large text sample, meaning that it has a one-to-one correspondence of documents. For example the Hansards of the Canadian legislature are published in both French and English and may be used as aligned, parallel collections of text. Such a collection may be used to find an appropriate French translation for an English word by searching the English collection for documents relevant to the word to be translated, selecting the set of French documents that are translations of the retrieved English documents, extracting a set of important terms from the French documents so selected, and identifying the set's term or terms having the greatest importance as possible translation(s). When this method is applied to an unsensed collection, a word that has many different translations (such as ‘bank,’ which may be translated into French either as ‘banque’ for a financial bank or as ‘rive’ for a river bank) may lead to an inappropriate translation. If, however, the English documents have senses assigned to their words, then each such sense may be translated to different, sense appropriate, terms. More specifically, a first French term of the set of important terms may be used as a trigger term and combined with the English search term to find a plurality of important terms relating to their combination, those terms defining a sense. This can be performed for multiple French terms of the set of important terms to define multiple senses that may define alternative French “translations” for the corresponding English term.

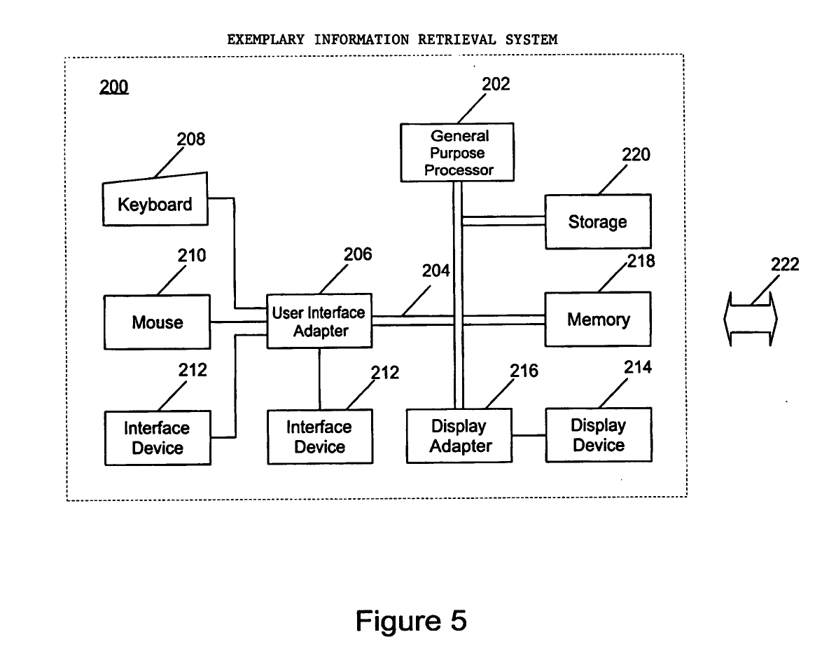

FIG. 5 is a block diagram of an information processing system in accordance with the present invention. As is well known in the art, the information processing system of FIG. 5 includes a general purpose microprocessor (CPU) 202 and a bus 204 employed to connect and enable communication between the microprocessor 202 and the components of the information processing system 200 in accordance with known techniques. The information processing system 200 typically includes a user interface adapter 206, which connects the microprocessor 202 via the bus 204 to one or more interface devices, such as a keyboard 208, mouse 210, and/or other interface devices 212, which can be any user interface device, such as a touch sensitive screen, digitized entry pad, etc. The bus 204 also connects a display device 214, such as an LCD screen or monitor, to the microprocessor 202 via a display adapter 216. The bus 204 also connects the microprocessor 202 to memory 218 and long-term storage 220 (collectively, “memory”) which can include a hard drive, diskette drive, tape drive, etc.

The information processing system 200 may communicate with other computers or networks of computers, for example via a communications channel, network card or modem 222. The information processing system 200 may be associated with such other computers in a local area network (LAN) or a wide area network (WAN), or the information processing system 200 can be a client or server in a client/server arrangement with another computer, etc. All of these configurations, as well as the appropriate communications hardware and software, are known in the art.

Software programming code for carrying out this inventive method is typically stored in memory. Accordingly, the information processing system 200 stores in its memory microprocessor executable instructions.

When the information processing system 200 is configured for determining a sense of a source term of a document, the system stores in its memory a first program for identifying a trigger term relating to a source term, and a second program for identifying a plurality of important terms relating to a combination of the source term and the trigger term.

When the information processing system 200 is configured for assigning a sense to a document's term for facilitating sense-relevant retrieval of the document by an information retrieval system, it stores in its memory a first program for identifying a term of the document, a second program stored for identifying a first sense for the term, a third program for comparing the first sense to the document to determine similarity, and a fourth program for assigning the first sense to the term if the first sense and the document are sufficiently similar.

When the information processing system 200 is configured for preparing a group of documents for sense-relevant retrieval by an information retrieval system, it stores in its memory a first program for creating an index for the group of documents. The index associates each of a plurality of term identifiers with a corresponding set of document identifiers. Each of the plurality of term identifiers is associated with a term and each of the sets of document identifiers is associated with a document. It further stores in its memory a second program for identifying, for each of the term identifiers, a sense corresponding to a respective term and a respective document associated with a respective one of the corresponding set of document identifiers. The sense includes a plurality of important terms. It also stores a third program for creating, for each of the term identifiers, at least one sensed term identifier, each sensed term identifier corresponding to a respective term identifier and a corresponding sense; and a fourth program stored for creating a sensed index for the group of documents. The sensed index associates each of the sensed term identifiers with a corresponding set of document identifiers. Each of the sensed term identifiers is associated with a term and a sense.

Having thus described particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

1. A method for determining a sense of a source term of a document, the method comprising the steps of:
(a) identifying a trigger term relating to said source term;
(b) identifying a plurality of important terms relating to a combination of said source term and said trigger term; and
(c) establishing a sense of said source term, said sense comprising said plurality of important terms.

2. The method of claim 1, wherein step (c) comprises the step of:
(c1) storing said plurality of important terms in association with said source term.

3. The method of claim 1, wherein step (a) comprises the step of:
(a1) searching a group of documents for terms important to said source term.

4. The method of claim 1, wherein step (a) comprises the steps of:
(a1) determining a reference frequency for each of a plurality of terms of a reference text, said reference frequency comprising a frequency of occurrence within said reference text;
(a2) identifying a sample text comprising documents comprising said source term;
(a3) determining a sample frequency for each of a plurality of terms of said sample text, said sample frequency comprising a frequency of occurrence within said sample text;
(a4) for each of said plurality of terms of said sample text, comparing a respective sample frequency to a respective reference frequency to determine importance as a function of said respective frequencies by calculating a difference between said respective sample frequency and said respective reference frequency;
(a5) assigning an importance score to each of said plurality of terms of said sample text, said importance score being determined as a function of said difference; and
(a6) defining a plurality of trigger terms to comprise each of said plurality of terms of said sample text having a respective importance score exceeding a threshold.

5. The method of claim 1, wherein step (b) comprises the step of:
(b1) searching a group of documents for terms important to said source term.

6. The method of claim 1, wherein step (b) comprises the steps of:
(b1) determining a reference frequency for each of a plurality of terms of a reference text, said reference frequency comprising a frequency of occurrence within said reference text;
(b2) identifying a sample text comprising documents comprising said source term;
(b3) determining a sample frequency for each of a plurality of terms of said sample text, said sample frequency comprising a frequency of occurrence within said sample text;
(b4) for each of said plurality of terms of said sample text, comparing a respective sample frequency to a respective reference frequency to determine importance as a function of said respective frequencies by calculating a difference between said respective sample frequency and said respective reference frequency;
(b5) assigning an importance score to each of said plurality of terms of said sample text, said importance score being determined as a function of said difference; and
(b6) defining said plurality of important terms to comprise each of said plurality of terms having a respective importance score exceeding a threshold.

7. A method for determining senses of a source term, the method comprising the steps of:
(a) identifying a plurality of trigger terms relating to said source term;
(b) for one of said plurality of trigger terms, identifying a plurality of important terms relating to a combination of said source term and said one of said plurality of trigger terms, said plurality of important terms comprising a sense of said source term;
(c) removing from said plurality of trigger terms all of said plurality of important terms, if any, to define a reduced plurality of trigger terms; and
(d) for one of said reduced plurality of trigger terms, identifying a next 11 plurality of important terms relating to a combination of said source term and said one of said reduced plurality of trigger terms, said next plurality of important terms comprising a next sense of said source term.

8. The method of claim 7, wherein step (a) comprises the steps of:
(a1) determining a reference frequency for each of a plurality of terms of a reference text, said reference frequency comprising a frequency of occurrence within said reference text;
(a2) identifying a sample text comprising documents comprising said source term;
(a3) determining a sample frequency for each of a plurality of terms of said sample text, said sample frequency comprising a frequency of occurrence within said sample text;
(a4) for each of said plurality of terms of said sample text, comparing a respective sample frequency to a respective reference frequency to determine importance as a function of said respective frequencies by calculating a difference between said respective sample frequency and said respective reference frequency;
(a5) assigning an importance score to each of said plurality of terms of said sample text, said importance score being determined as a function of said difference; and
(a6) defining said plurality of trigger terms to comprise each of said plurality of terms having a respective importance score exceeding a threshold.

9. A method for assigning a sense to a document's term for facilitating sense-relevant retrieval of said document by an information retrieval system, the method comprising the steps of:
identifying a term of said document;
identifying a first sense for said term, said first sense comprising terms relating to said term;
comparing said first sense to said document to determine similarity;
assigning said first sense to said term if said first sense and said document are sufficiently similar.

10. The method of claim 9, further comprising the steps of:
identifying a next sense for said term if said first sense and said document are not sufficiently similar, said sense comprising terms relating to said term;
comparing said next sense to said document to determine similarity; and
assigning said next sense to said term if said next sense and said document are sufficiently similar.

11. The method of claim 9, wherein said comparing step is performed using a cosine measure technique.

12. The method of claim 9, wherein said assigning step comprises storing data associating said term with said first sense.

13. The method of claim 9, wherein said identifying step comprises referencing a memory storing a plurality of senses, each of said plurality of senses comprising a plurality of terms.

14. A method for assigning a sense to a document's term for facilitating sense-relevant retrieval of said document by an information retrieval system, the method comprising the steps of:
identifying a term of said document;
identifying a plurality of senses for said term, each of said plurality of senses 6 comprising a plurality of terms;
comparing each of said plurality of senses to said document to determine similarity,
assigning to said term a sense of said plurality of senses determined to have the greatest similarity.

15. The method of claim 14, wherein said comparing step comprises the step of generating a similarity score for each of said plurality of senses, and wherein said assigning step comprises the step of assigning to said term said sense of said plurality of senses determined to have the highest similarity score.

16. A method for preparing a group of documents for sense-relevant retrieval by an information retrieval system, the method comprising the steps of:
(a) creating an index for said group of documents, said index associating each of a plurality of term identifiers with a corresponding set of document identifiers, each of said plurality of term identifiers being associated with a term, each of said set of document identifiers being associated with a document;
(b) for each of said term identifiers, identifying a sense corresponding to a respective term and a respective document associated with a respective one of said corresponding set of document identifiers, said sense comprising a plurality of important terms;
(c) for each of said term identifiers, creating at least one sensed term identifier, each said sensed term identifier corresponding to a respective term identifier and a corresponding sense; and
(d) creating a sensed index for said group of documents, said sensed index associating each of said sensed term identifiers with a corresponding set of document identifiers, each of said sensed term identifiers being associated with a respective term and a respective sense.

17. An information processing system for determining a sense of a source term of a document, the system comprising:
a central processing unit (CPU) for executing programs;
a memory operatively connected to said CPU;
a first program stored in said memory and executable by said CPU for identifying a trigger term relating to said source term; and
a second program stored in said memory and executable by said CPU for identifying a plurality of important terms relating to a combination of said source term and said trigger term, said sense comprising said plurality of important terms.

18. An information processing system for assigning a sense to a document's term for facilitating sense-relevant retrieval of the document by an information retrieval system, the system comprising:
a central processing unit (CPU) for executing programs;
a memory operatively connected to said CPU;
a first program stored in said memory and executable by said CPU for identifying a term of said document;
a second program stored in said memory and executable by said CPU for identifying a first sense for said term, said sense comprising terms relating to said term;
a third program stored in said memory and executable by said CPU for comparing 11 said first sense to said document to determine similarity; and
a fourth program stored in said memory and executable by said CPU for assigning said first sense to said term if said first sense and said document are sufficiently similar.

19. An information processing system for preparing a group of documents for sense-relevant retrieval by an information retrieval system, the system comprising:
a central processing unit (CPU) for executing programs;
a memory operatively connected to said CPU;
a first program stored in said memory and executable by said CPU for creating an index for said group of documents, said index associating each of a plurality of term identifiers with a corresponding set of document identifiers, each of said plurality of term identifiers being associated with a term, each of said set of document identifiers being associated with a document;
a second program stored in said memory and executable by said CPU for identifying, for each of said term identifiers, a sense corresponding to a respective term and a respective document associated with a respective one of said corresponding set of document identifiers, said sense comprising a plurality of important terms;
a third program stored in said memory and executable by said CPU for creating, for each of said term identifiers, at least one sensed term identifier, each said sensed term identifier corresponding to a respective term identifier and a corresponding sense; and
a fourth program stored in said memory and executable by said CPU for creating a sensed index for said group of documents, said sensed index associating each of said sensed term identifiers with a corresponding set of document identifiers, each of said sensed term identifiers being associated with a respective term and a respective sense.

20. An information processing system for facilitating sense-relevant retrieval of a document by an information retrieval system, the system comprising:
a central processing unit (CPU) for executing programs;
a memory operatively connected to said CPU;
a document stored in said memory, said document comprising a term; and
data stored in said memory associating said term with a sense comprising a plurality of terms.

21. The information processing system of claim 20, further comprising:
data stored in said memory identifying said plurality of terms.

22. The information processing system of claim 21, further comprising:
a first program stored in said memory and executable by said CPU for comparing said plurality of terms to a search query.

23. The information processing system of claim 22, further comprising:
a second program stored in said memory and executable by said CPU for identifying said document as a relevant search result for said search query if said first program determines sufficient similarity between said plurality of terms and said search query.
